(19) United States
(12) Patent Application Publication
(10) Pub. No.: US 2013/0332440 A1
(43) Pub. Date: Dec. 12, 2013

(54) Refinements in Document Analysis

(71) Applicant: Remeztech Ltd., (US)

(72) Inventors: Haim BARAD, Zichron Yaakov (IL); Marina GRECHUHIN, Ganei Tikva (IL); Jonathan SKELKER, Zichron Yaakov (IL)

(73) Assignee: Remeztech Ltd., Zichron Yaakov (IL)

(21) Appl. No.: 13/828,940

(22) Filed: Mar. 14, 2013

Related U.S. Application Data
(60) Provisional application No. 61/638,499, filed on Apr. 26, 2012.

(51) Int. Cl. G06F 17/30

(52) U.S. Cl. CPC G06F 17/3053
USPC 707/706; 707/748

(57) ABSTRACT

A system and method for mark-up language document rank analysis that may be performed automatically and that may also determine one or more differences between mark-up language documents with regard to their relative rank.

This Application claims priority from U.S. Provisional Application No. 61/638,499, filed on 26 Apr. 2012 which is hereby incorporated by reference as if fully set forth herein.

### FIELD OF THE INVENTION

The present invention is of a system and method for refinements in document analysis, and in particular but not exclusively, to such a system and method that is useful for determining one or more differences between mark-up language documents with regard to their relative rank.

### BACKGROUND OF THE INVENTION

Search engines play important roles for supporting user interactions with the Internet. Search engines often act as a “gateway” to the Internet for many users, who use them to locate information of interest as a first resource. They are practically indispensable for negotiating the many billions of web pages that form the World Wide Web.

Many users typically review only the first page or first few pages of search results that are provided by a search engine. For this reason, owners of web sites alter their web pages to increase their rank, whether by making the pages more “friendly” to spiders or by altering content, layout, tags and so forth. This process of changing a web page to increase its rank is known as SEO or “search engine optimization”.

Currently search engine optimization is typically performed manually. Search engines carefully guard their rules and algorithms for determining rank, both against competitors and also to avoid “spam” web pages which do not provide useful content but which seek only to have a high ranking, for example to attract advertisers. However, manual analysis and adjustments are highly limited and may miss many important improvements to web pages that could raise their rank in search engine results. Additionally, manual SEO is a complex and skilled task not typically known to the writers of internet content.

### SUMMARY OF AT LEAST SOME ASPECTS OF THE INVENTION

The background art does not teach or suggest a system and method for mark-up language document rank analysis that may be performed automatically and that may also determine one or more differences between mark-up language documents with regard to their relative rank.

The present invention overcomes these drawbacks of the background art by providing, in at least some embodiments, a system and method for mark-up language document rank analysis that may be performed automatically and that may also determine one or more differences between mark-up language documents with regard to their relative rank.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative non-limiting system according to some embodiments of the present invention;

FIG. 2A shows the operation of an analysis subsystem according to at least some embodiments of the present invention, which may optionally relate to the analysis subsystem of FIG. 1, in more detail, while FIG. 2B shows an exemplary decision boundary in an exemplary two dimensional feature space;

FIG. 3 relates to a non-limiting, illustrative method for providing efficient suggestions for changing a mark-up language document according to at least some embodiments of the present invention;

FIG. 4 relates to a non-limiting, illustrative method for bounding the efficient suggestions for changing a mark-up language document of the method of FIG. 3 according to at least some embodiments of the present invention;

FIG. 5 relates to a non-limiting, illustrative method for determining pricing for a template based mark-up language document according to relative ranking according to at least some embodiments of the present invention; and

FIG. 6A relates to a non-limiting, illustrative method for predicting the effect of a specific change to a mark-up language document on an expected number of views of the document according to at least some embodiments of the present invention, while some non-limiting examples of results obtained by the method are shown in FIG. 6B, which has a logarithmic y-axis and hence which is an exponentially decaying curve.

### DESCRIPTION OF THE PREFERRED EMBODIMENTS

The present invention is, in at least some embodiments, of a system and method for mark-up language document rank analysis that may be performed automatically and that may also determine one or more differences between mark-up language documents with regard to their relative rank.

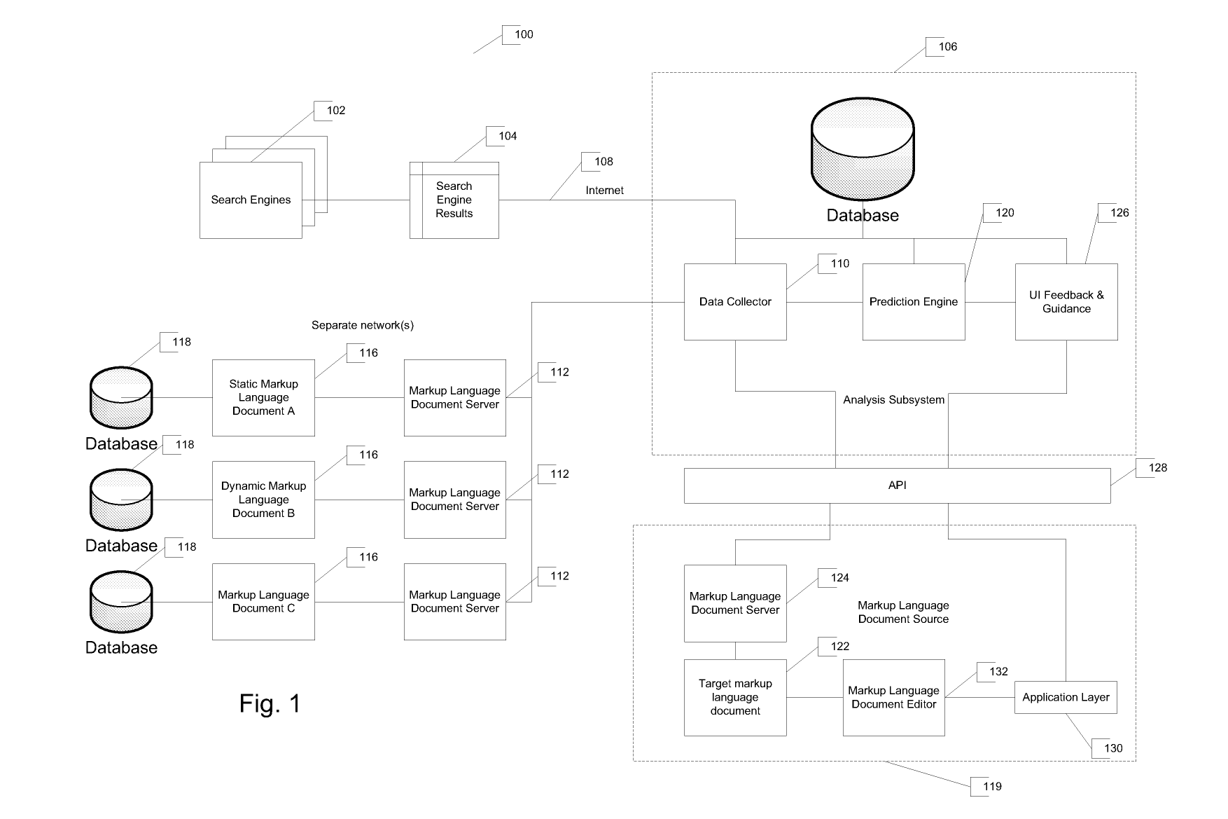

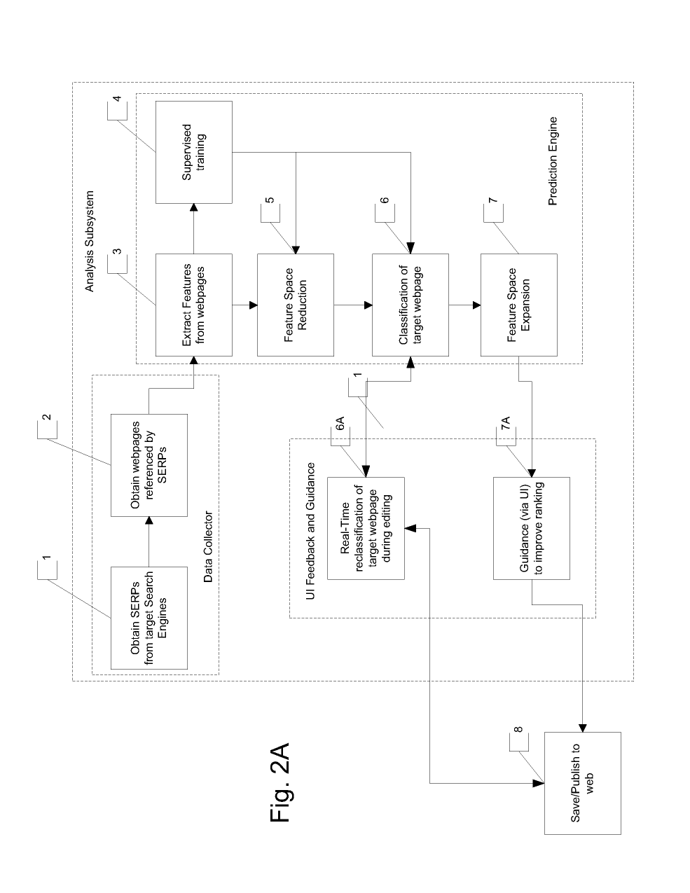

Referring now to the drawings, FIG. 1 shows an exemplary, illustrative non-limiting system according to some embodiments of the present invention. As shown, a system 100 features a plurality of search engines 102 as non-limiting examples of computer network based indexing programs for indexing mark-up language documents, which are preferably internet based indexing computer programs for indexing such mark-up language documents. Such programs assist users to locate content based upon one or more parameters such as keyword searches for example, typically by using indexes of mark-up language documents such as web pages for example. Typically search engines 102 return a plurality of mark-up language document results by returning a plurality of links to such documents to a computer of the requestor of the search, such as for example a plurality of URLs. Search engines 102 are shown in FIG. 1 as returning a plurality of search results 104 to an analysis subsystem 106 through a computer network 108, which may optionally be the internet for example. Analysis subsystem 106 is typically operated by one computer or a plurality of computers, and/or through distributed computing, as non-limiting examples.

Analysis subsystem 106 optionally and preferably receives such search results 104 in response to a query, which is preferably formatted as for any search engine query (for example, containing one or more keywords). The query is preferably generated and transmitted by a data collector 110, which also receives search results 104.

Data collector 110 also preferably obtains the mark-up language documents associated with search results 104, for example by downloading such documents from a server. As non-limiting examples, data collector 110 is shown as being in communication with a plurality of mark-up language document servers 112 through a computer network 114, which may optionally also be the Internet and/or otherwise the same computer network as computer network 108. Data collector 110 preferably receives one or more mark-up language documents 116 according to the search results 104, for example according to a URL or other address for a particular mark-up language document server 112, which is supplied with search results 104. Data collector 110 may optionally retrieve or “pull” a mark-up language document 116 or alternatively may have such a mark-up language document 116 “pushed” or sent to data collector 110.

Each mark-up language document server 112 is shown as providing a different type of mark-up language document 116 (although of course each server 112 may or may not be limited to a particular type of mark-up language document 116), with non-limiting examples including a static mark-up language document A 116, a dynamic mark-up language document B 116 or a mark-up language document C 116. Each mark-up language document server 112 optionally retrieves each such mark-up language document 116 from a database 118 as shown.

Data collector 110 then preferably passes these results and one or more of the above described mark-up language documents 116 to a prediction engine 120, which as shown is also part of analysis subsystem 106. As described in greater detail below, prediction engine 120 then analyzes the received search results 104 and also the corresponding mark-up language documents 116 with regard to the relative ranking of a plurality of mark-up language documents 116, and also by comparing one or more features within the plurality of mark-up language documents 116 according to their relative rank.

Additionally or alternatively, prediction engine 120 may also optionally compare one or more features of a target mark-up language document 122 to such one or more features in mark-up language documents 116, with regard to a relative rank of target mark-up language document 122 in comparison to mark-up language documents 116, as determined in search results 104.

Target mark-up language document 122 is preferably provided by a target mark-up language document source 119, which preferably comprises a target mark-up language document server 124. Target mark-up language document server 124 is preferably in communication with data collector 110, preferably through an API (application programming interface) 128, and also optionally through any computer network 106 as previously described (alternatively, target mark-up language document server 124 may optionally be in direct communication with data collector 110, for example through an internal network and/or as part of a particular computational hardware installation). Data collector 110 may optionally “pull” target mark-up language document 122 from target mark-up language document server 124 or alternatively may have target mark-up language document 122 “pushed” by target mark-up language document server 124.

The comparative analysis of target mark-up language document 122 with regard to mark-up language documents 116 is described in greater detail below, but preferably includes determining at least one difference between target mark-up language document 122 and mark-up language documents 116 with regard to relative rank. Optionally such a difference could for example explain a relatively lower rank of target mark-up language document 122 with regard to one or more mark-up language documents 116.

The results of the analysis may optionally be adjusted according to feedback from a user, which provided through a UI feedback and guidance module 126.

Analysis subsystem 106 is optionally in communication with one or more additional external computers or systems, which is preferably performed through one or more APIs (application programming interfaces) 128. In this exemplary system 100, API 128 supports communication between UI feedback and guidance module 126 and an application layer 130, which for example may optionally support a user interface (UI, not shown) for communication with UI feedback and guidance module 126.

Target mark-up language document source 119 also preferably features a mark-up language document editor 132, which may either optionally perform one or changes on target mark-up language document 122 automatically or alternatively (or additionally) according to one or more user inputs, for example through application layer 130. For example, UI feedback and guidance module 126 may also optionally provide inputs as to one or more proposed changes to target mark-up language document 122 to increase the relative rank of target mark-up language document 122 with regard to the plurality of mark-up language documents 112 obtained in the search results. Such inputs are preferably provided to application layer 130, whether for user approval or for automatic implementation by mark-up language document editor 132.

Alternatively or additionally, the user may perform one or more changes to target mark-up language document 122, whether through application layer 130 or directly through mark-up language document editor 132, after which the changed document is reanalyzed by prediction engine 120, to see whether the expected relative rank would be higher or lower, as described in greater detail below.

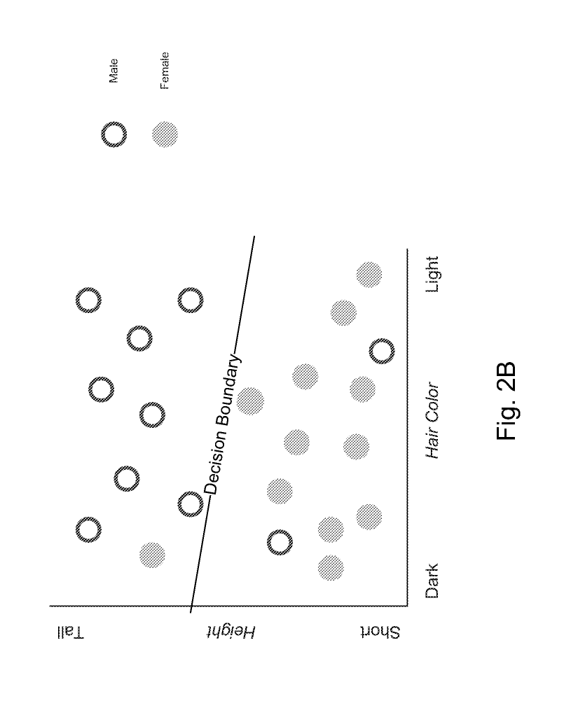

FIG. 2A shows the operation of an analysis subsystem according to at least some embodiments of the present invention, which may optionally relate to the analysis subsystem of FIG. 1, in more detail. As shown, in stage 1, data collector obtains the search results from one or more search engines. In stage 2, data collector obtains the mark-up language document pages, such as web pages for example, according to the search results; for example and without limitation, the search results may include URLs or other address information for the mark-up language documents. For this exemplary method and without wishing to be limited, the description will relate to web pages as the mark-up language documents.

Stages 3-7 are then performed by the prediction engine. In stage 3, the prediction engine extracts one or more features from the web pages as described in greater detail below. In stage 4, the prediction engine preferably performs supervised training of an analysis algorithm with regard to such features.

Supervised training is a machine learning methodology whereby examples from a known set of classes are fed into a system with the class identifiers. Often the input samples are in the form of an N-dimensional feature vectors. The system is trained with these samples and class identifiers and the resultant model is called a classifier.

Ideally, the classifier should be able to classify the entire training set (now without the given class identifiers) correctly. The entire process of learning from a set of sample feature vectors is called “training the classifier”.

Once training is complete, the classifier is then used to classify unlabeled data into classes. This can be done through a variety of methods that typically rely on determining relative similarities between classes (as determined during training) and the new input vectors.

A simple example of supervised training is the ability to distinguish between males and females based on just two features. The first feature is height and the second feature is hair color. Clearly from a priori knowledge, it is known that height is more likely to be a usefully distinguishing feature than is hair color. The process starts by obtaining training samples from a selected and known training set of male and female participants. A feature vector (2-dimensional) is extracted from each of the training samples and plotted in a two-dimensional feature space, with one dimension for each feature. As seen from the example (FIG. 2b), the male population tends to be taller (that is, the male and female populations may be more accurately separated by height) and a decision boundary is calculated for the feature of “height”. While the separation between the two classes is not 100% accurate, it is possible to classify new samples with reasonable accuracy. For greater accuracy, it would be necessary to enhance the classifier by adding new features. In any case, the classifier can be used now to classify unknown samples based on the calculated decision boundary.

The main advantage of supervised training is the construction of the classifier is often more accurate and reliable than for unsupervised training, because the training set had a known set of class identifiers. For the presently described method, it is possible to leverage supervised training methods because the search engines provide the rankings in the Search Engine Result Pages. The supervised training is not limited to training by search engine rankings but may instead optionally include other classification information for training purposes.

In stage 5, the prediction engine optionally performs reduction of the dimensionality of the feature space, to locate one or more features considered to be of particular importance in determining the relative rank of the target after the supervised training. Therefore, subsequent stages may optionally be performed with lower dimensionality. Non-limiting examples of algorithms for feature space reduction include PCA (principle component analysis).

In stage 6, the prediction engine classifies the target web page according to the N dimensional feature space and according to the decision boundary. Optionally one or more features are weighted with regard to its respective decision boundary such that in cases where the classification of the target web page with regard to that feature is not clear, the decision may optionally be weighted toward a particular side of the boundary. Weights on each feature determine the decision boundary which may for example optionally be characterized by a multidimensional hyperplane or other methods of segmenting the feature space, or for example through application of decision tree logic. In stage 7 the prediction engine then performs feature space expansion in which the engine determines which features have the most effect on altering the rank of the target web page with regard to the other ranked web pages.

Optionally stages 5 and 6 are not performed, for example if the method is not to be performed in real time, in which case the method optionally proceeds from stage 4 directly to stage 6A as described below.

From stage 6 the process may also optionally be performed by the UI feedback and guidance module in stage 6A, which may optionally perform real time reclassification of the target web page according to input through the web page editor. Also from stage 7, the process may also optionally be performed by the UI feedback and guidance module in stage 7A, which may optionally provide guidance to the user (or to an automated web page editor) with regard to whether one or more changes are likely to improve or reduce the rank of the web page with regard to the other analyzed web pages.

In stage 8, optionally such information is provided to the user and/or through the web; for example, optionally the altered webpage is published to the Internet by being uploaded to a web server.

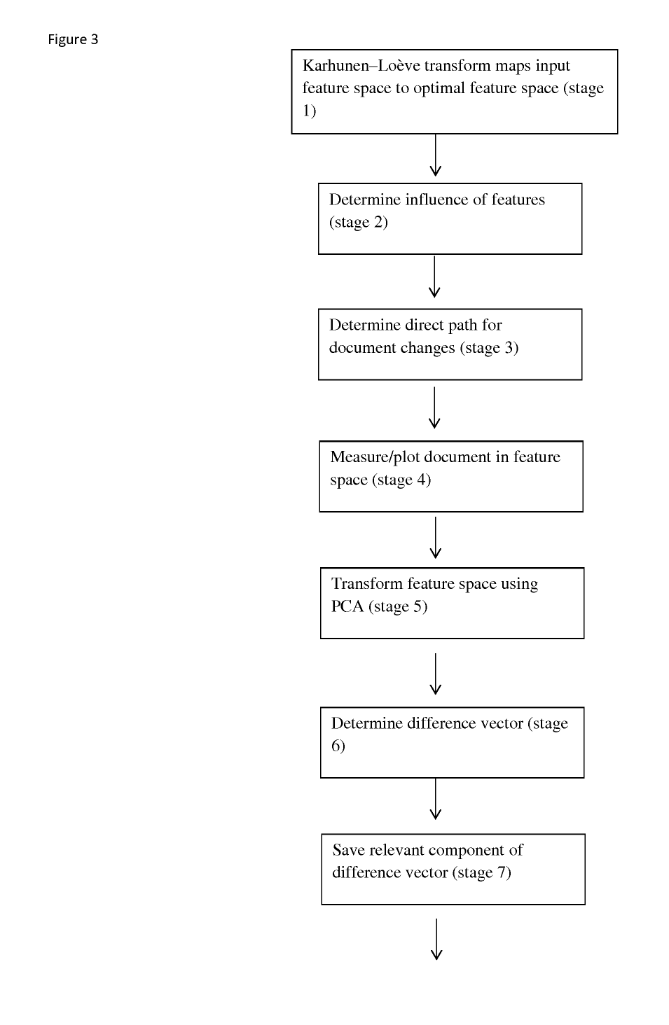

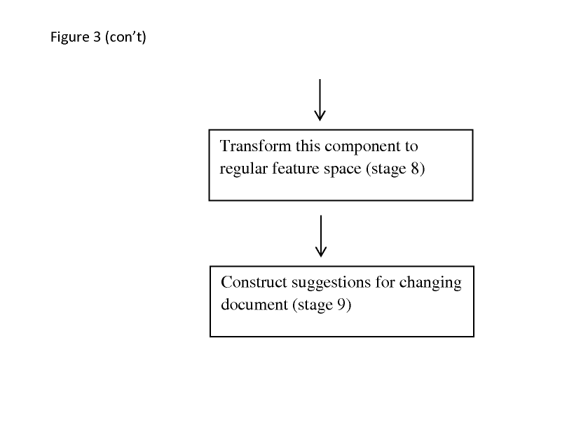

FIG. 3 relates to a non-limiting, illustrative method for providing efficient suggestions for changing a mark-up language document. Without wishing to be limited in any way, this method enables the user to make relatively few (or at least relatively fewer) changes to a mark-up language document in order to achieve a desired result, such as for example an increase in rank as determined by a search engine.

Also without wishing to be limited in any way, the method described herein may optionally be performed with regard to a method of eigenvector space mapping for optimal correction via actionable suggestions. The below exemplary method is described with regard to such a type of space mapping for the purpose of description only and without any intention of being limiting.

In stage 1, a Karhunen-Loève transform maps an input feature space into a decorrelated and orthogonal feature space that is optimal (by minimizing mean squared error) with regards to dimensionality reduction. This transformation is important since the input feature space suffers from correlated features and therefore movements along specific features in feature space can and will affect positions along other feature basis vectors.

This mapping is performed by solving an eigensystem of the correlation matrix and transforming the data into this orthogonal space (one method Principal Components Analysis). The transformation is not limited to the Karhunen-Loève transform as other methods (Singular Value Decomposition) can be used instead. The transformation enables the operation to move into a decorrelated and orthogonal feature space to better provide improved discrimination while using a reduced feature space.

In stage 2, the influence of these decorrelated features to ranking may optionally be determined, for example with regard to search engine behavior as previously described. These new orthogonal features in the new feature space can be ordered by the magnitude of their corresponding eigenvalue, thus ordering the features in terms of variance (and therefore their ability to discriminate). Those features with largest magnitude of eigenvalues are the most useful in discrimination necessary to provide ranking, improvement suggestions, etc.

In stage 3, the document under examination is measured and plotted in feature space (and a target position for high-rank is also known in feature space)

Once a ranking is determined in transformed space, a direct path can be determined to guide changes of the document to achieve an improved rank position in stage 4.

However, this direct path is not readily understood by a human user (although an automated computer system could implement along a direct path), as it is determined in the transformed space, with axes that do not correspond to intuitive features (and therefore are difficult to map into actionable suggestions). The subsequent stages relate to an optionally exemplary method to decompose this optimal path into actionable suggestions so that minimal work is done to achieve higher ranking.

In stage 5, data in the feature space is transformed using PCA (Principal Components Analysis) or one of several other transformation methods that may be used.

In stage 6, given the transformed data for the document being written and a desired position (also transformed), a difference vector is computed which represents the changes needed in an orthogonal feature space to correct the document based on independent corrections along the transformed (orthogonal) feature space.

In order to provide a simple but highly effective set of suggestions, the components of this difference vector corresponding to the axes that corresponds to the largest eigenvalues in the transformed feature space is saved in stage 7.

These suggestions (which will incrementally move the document's location in feature space) provide a set of suggestions that can be ordered from those proving the most benefit to those providing the least benefit. A user can later make most efficient use of his or her time by deciding on following the most important features first and possibly terminate the “improvement work” in terms of editing or otherwise adjusting the HTML document on the basis of a cost-benefit analysis. For example, this can be done after the inverse PCA (or other inverse transformational) step.

This component of the difference vector is now transformed back into the regular feature space (inverse PCA or another inverse of the previously described method is used) in stage 8.

In stage 9, the features are used to construct suggestions for the author/editor of the document.

Optionally or additionally, other types of statistical analyses may be used to analyze the web page and then to guide the author/editor to make changes as described above.

For example, such analyses may optionally use higher order, multivariate statistical analysis for determining webpage quality (and ultimately rank prediction). Higher order statistics are needed to include more complex features (e.g. skewness) and multivariate analysis is required to properly analyze the features concurrently (as opposed to looking at each feature in isolation).

Text that is natural and rich will exhibit different statistical characteristics than text that only obeys univariate statistics on word usage.

For example, many higher order features, including but not limited to entropy, variance, angular second moment, inverse difference moment, contrast correlation, difference entropy and so forth can be calculated and provide characteristics of the richness of the text (using standard measures analogous to co-occurrence matrices and other types of multivariate analysis in conjunction with these specific statistical features).

Often webpage analysis is done one feature at a time (e.g. keyword density) and isolated from other features that might be looked at in a subsequent step, thus implying that the features are orthogonal, when they clearly are not. In other words, preferably at least one statistical measure is applied which considers a plurality of language features simultaneously.

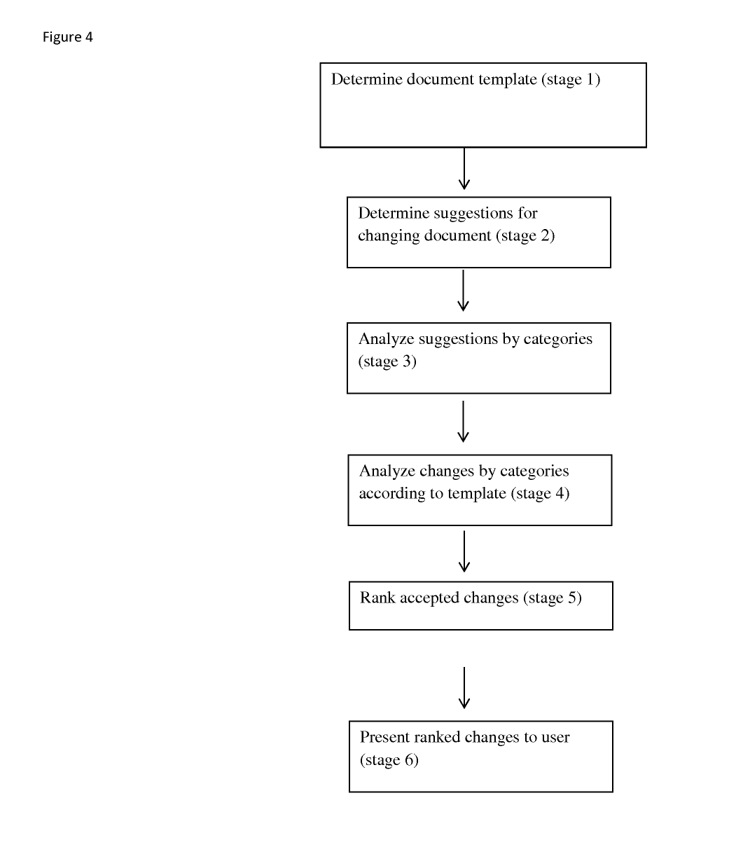

FIG. 4 relates to a non-limiting, illustrative method for bounding the efficient suggestions for changing a mark-up language document of the method of FIG. 3 according to at least some embodiments of the present invention.

As shown, in stage 1, a template is determined for a mark-up language document. The template preferably relates to different types of text (title, section header, descriptive content and so forth), graphics and images. The template may optionally relate to a web page or a plurality of web pages, for example.

In stage 2, the method of FIG. 3 is performed (or another similar method for providing suggestions for changes to the document).

In stage 3, each suggestion is analyzed with regard to the change required in the document. In particular, preferably the changes are divided into categories which include but are not limited to changes in existing document structure, changes in existing content, adding a new structure or adding new content.

In stage 4, the change in each category is analyzed with regard to the template, to determine the relative ease of making each change. For example, if a suggestion relates to changing existing content, the change may optionally be determined to be relatively easy, unless the changes required are so extensive so as to be difficult to implement. Items to be changed fall into different categories, which range in difficulty from simple content changes such as title or font, to extensive revisions (for example to handle apparently duplicate content). Some revisions may be counter to a desired marketing effect with the website, such as for example changing the domain name.

However, changes to the structure of the document, or adding a new structure, may optionally be immediately rejected as being not possible within the limitations of the provided template. Adding new content may optionally be analyzed according to whether a location for such new content is provided within the context of the template. If such a location is provided, then the addition of the new content may optionally be analyzed as previously described with regard to changing content. If such a location is not provided, then such a change may optionally be immediately rejected as being not possible within the limitations of the provided template.

In stage 5, changes which are accepted from stage 4 are then preferably ranked according to the relative ease of making such a change. “Relative ease” may optionally be determined heuristically, according to the prior mark-up language document editing experience of a plurality of users, or alternatively may optionally be determined through analyzing the number and type of changes required, or through a combination thereof.

In stage 6, the ranked suggested changes are presented to the user through a user computer as previously described. Optionally, such changes are presented to the user next to an editable display of the relevant mark-up language document, such that changes to the title of the document would optionally be displayed next to the title itself and so forth.

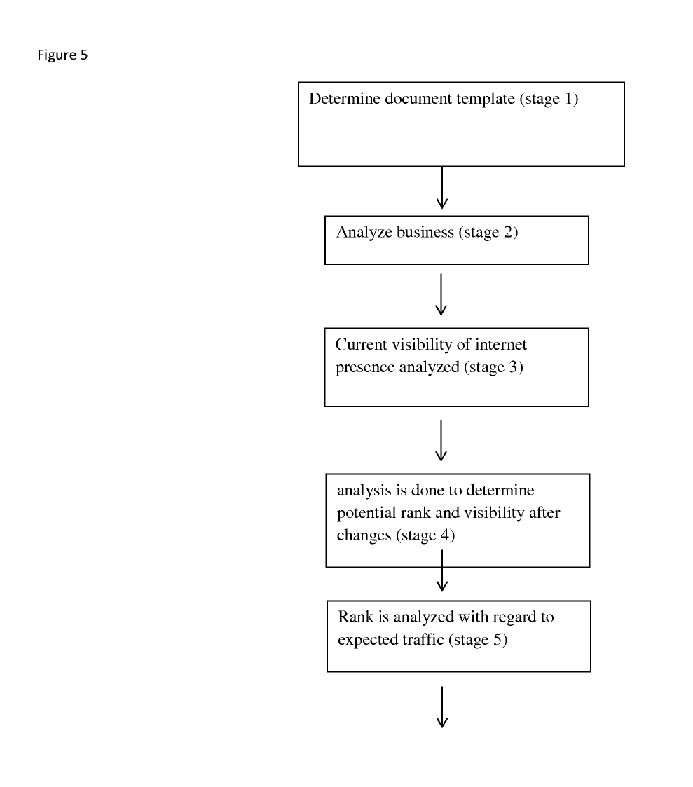

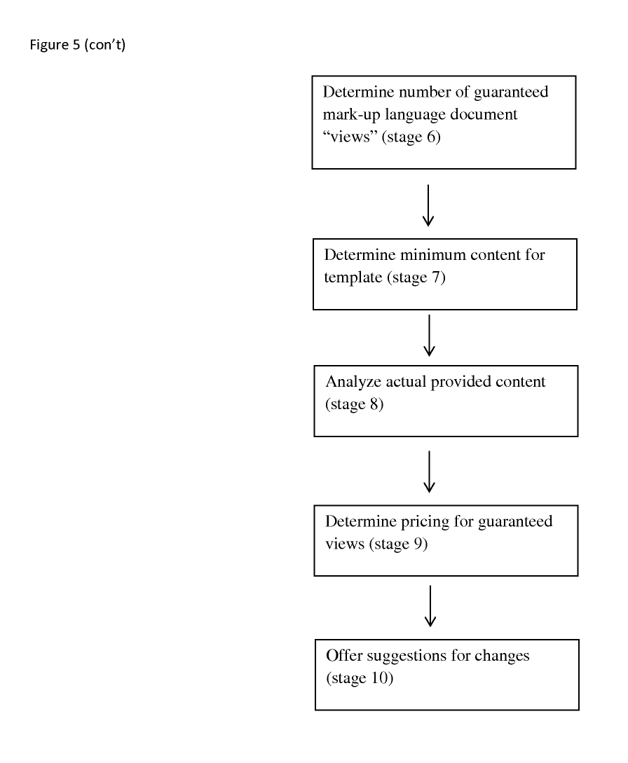

FIG. 5 relates to a non-limiting, illustrative method for determining pricing for a template based mark-up language document according to relative ranking according to at least some embodiments of the present invention.

As shown, in stage 1, a template is determined for a mark-up language document. The template preferably relates to different types of text (title, section header, descriptive content and so forth), graphics and images. For the purpose of discussion only and without intending to be limiting in any way, the template is assumed to be for a business web page. By “web page” it is also meant a plurality of web pages or a web site.

In stage 2, the business for which the web page is to be constructed is optionally analyzed according to a plurality of parameters. Preferably, such parameters include but are not limited to business size, type of business (i.e.—“B2B” in which products or services are sold to other businesses, “B2C” in which products or services are sold to consumers, and also whether the business relates to services, products or a combination thereof), type of product and/or service provided, geographic location (if required) and competition.

Geographic location is preferably analyzed for those businesses in which the physical location of the business is a factor. Non-limiting examples of such businesses include service businesses in which the service is provided at a specific location (plumbers, salons, dentists and the like) and product businesses in which products are to be consumed at a particular location or which are sold through a “bricks and mortar” store.

Competition may optionally be analyzed by determining the number and/or concentration of similar businesses in a particular area (for example, according to business licenses provided for a particular category of business within a geographical area). However, competition may also optionally relate, additionally or alternatively, to other businesses having such web pages within a particular business category and/or type of product and/or service provided, optionally further determined with regard to geographic location.

For example, with regard to stages 1 and 2, optionally the following (somewhat simplified) scenario may be performed. A small business is approached with the proposal of increasing traffic to its website. For a particular template type (e.g. business listing, 5-page website, social network page, etc), their business internet presence (in terms of traffic to their site and conversions as per their own business definition) is analyzed for content that can be presented online. For example, the term “conversion” may be defined differently for different types of businesses and so success in this area cannot be defined uniformly. This content must relate to the business type and then the business type is analyzed for amount of traffic on the internet related to searches for that product/service (in this geographically relevant location, if applicable), based upon that content.

In stage 3, the current visibility of the internet presence of the template document as described above is analyzed, based on rank in various search engines and social networks as well as traffic coming from a variety of sources.

In stage 4, an analysis is done to determine potential rank and visibility after changes and how difficult changes are to accomplish. This can be done via new or modified content, additional media or alternative presence via various incoming link sources or social networks. Difficulty may optionally relate to the amount of changes, amount of time required to make changes and so forth as described above.

In stage 5, this rank (or a plurality of possible rankings) is analyzed to determine the amount of traffic that would be realized by such a scenario and how valuable that traffic would be for that business type, considering a variety of factors such as customer acquisition costs, etc.

In stage 6, a number of guaranteed mark-up language document “views” or “visits” may optionally be determined. For example, for a business web page, the number of times that a web page is viewed (for example, accessed through the Internet by a web browser and then displayed to a user on a user computer) may comprise the parameter that determines whether the number of guaranteed views is reached.

The number of guaranteed views may optionally be predetermined independently of the particular business, but is preferably determined in conjunction with the business analysis of stage 2. The number of guaranteed views is based upon the predicted rank and a viewing model of exponential decay in search engine results, in which a slow decline in views is seen over each page of results, with a sharp drop between pages. To determine improvements and the number of guaranteed views to be offered, it is necessary to consider the current page rank for the specific webpage or for a model webpage, along with the current number of “clickthroughs” for the specific webpage or for a model webpage. Pricing may optionally be determined according to the extra traffic and also optionally according to business type and model (for example, a higher rank may be worth more for on-line businesses, and also may be worth more for “commodity” suppliers such as florists than for “reputational” suppliers such as doctors). Optionally stages 6 and 7 are switched in order.

In stage 7, optionally minimum content to be placed in the mark-up language document according to the template is determined. For example, for a business web page, optionally the name, address and telephone number (and also optionally email address, if available) forms part of the minimum content. Depending upon the requirements of the template, other minimum content may also optionally be required, such as a list of products/services offered, a description of the business, a logo and so forth. If the minimum content is not met, then optionally the user may be directed to perform one or more changes to the content (for example, according to the suggestions provided through the methods of FIGS. 3 and 4). For example, the user may optionally be provided with a questionnaire to complete with minimum content according to the business (restaurant-type of food, range of menu prices, average meal price, family friendly etc).

In stage 8, the actual provided content of the mark-up language document is analyzed with regard to expected search engine ranking, for example according to the system described in FIG. 2A. Typically a user searches for a web page of interest through a search engine, such as Google® as a non-limiting example. The results of the search are displayed in terms of their rank by the search engine, with higher ranked web pages being displayed first. It is assumed that the user is more likely to view higher ranked web pages; therefore, this analysis is assumed to correlate directly to frequency of viewing of the web page (as a non-limiting example of a mark-up language document).

In stage 9, the analysis of the business from stage 2, the number of guaranteed views from stage 6 and the content analysis from stage 8, optionally along with the parameters determined in the other stages, are preferably analyzed in order to determine pricing for the number of guaranteed views. The pricing is preferably determined according to a model that considers the relative difficulty of meeting the number of guaranteed views for a particular number of such views. Alternatively, the number of guaranteed views may not be determined in advance but rather may optionally be determined at this stage, along with pricing, for example according to the analysis of the business and the content analysis of the web page.

Pricing is then determined for one or more of various scenarios given the amount of work needed to realize that scenario and the benefit to the business based on a variety of factors analyzed previously.

In stage 10, if the pricing is rejected by the business, or alternatively as a standalone feature, an offer may be made to provide suggestions for improving the content (and hence improving the ranking and thereby reduce the price), for example according to the methods of FIGS. 3 and 4.

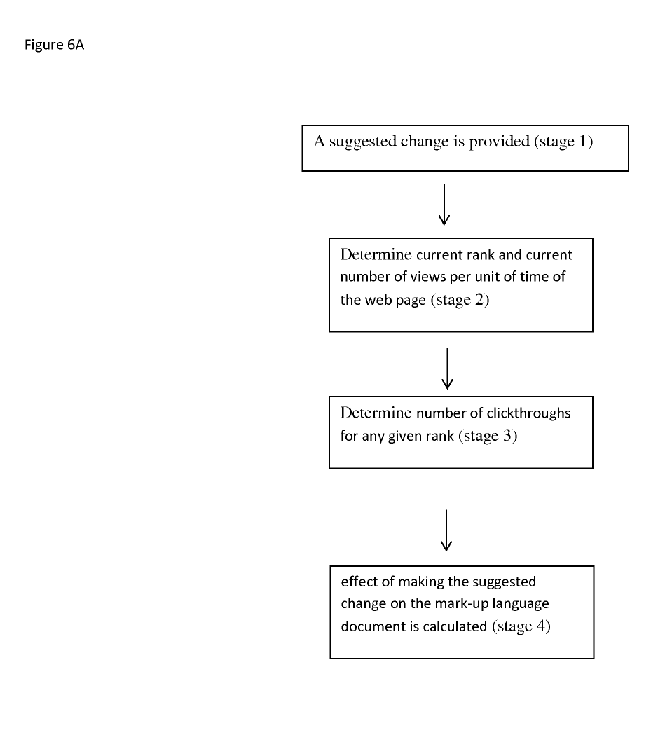

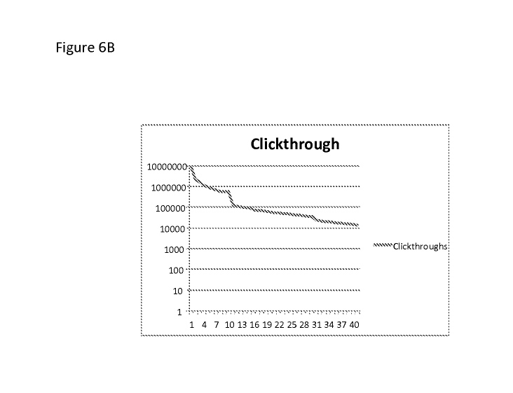

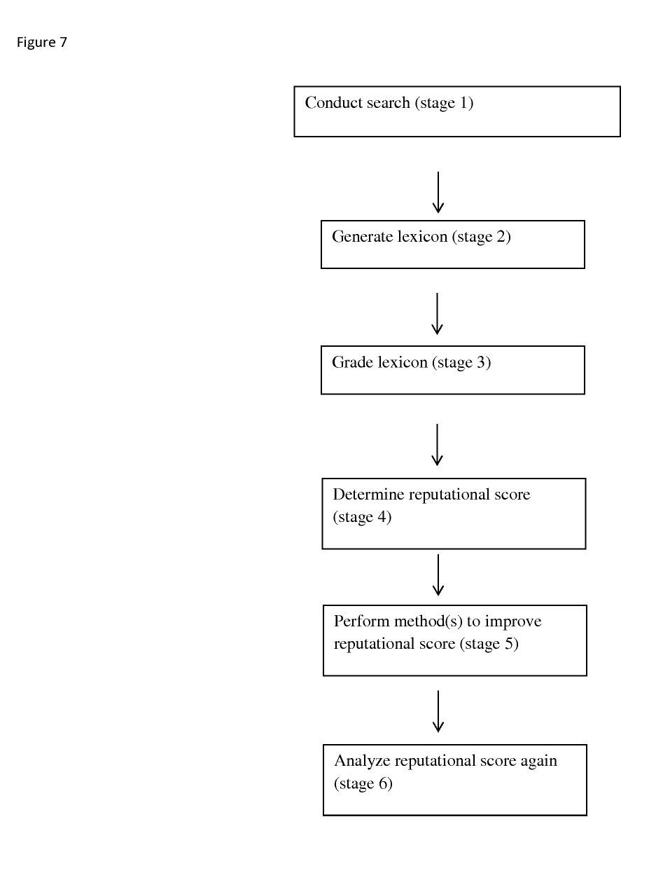

FIG. 6A relates to a non-limiting, illustrative method for predicting the effect of a specific change to a mark-up language document on an expected number of views of the document according to at least some embodiments of the present invention. This method may optionally be used with any of the above described methods, for example, or as a stand-alone method. For the purpose of discussion only and without wishing to be limiting in any way, it is assumed that the mark-up language document is a web page, that views of the document relate to views of a web page through a web browser and that relative ranking of the web page is determined with regard to a plurality of other web pages by a search engine as previously described. Some non-limiting examples of results obtained by the method are shown in FIG. 6B, which has a logarithmic y-axis and has an exponentially decaying curve.

As shown, in stage 1, a suggested change is provided, for example according to one of the above described methods, such as the method of FIG. 3 for example. In stage 2, the current rank and current number of views per unit of time of the web page is determined according to well known methods in the art. The rank may optionally be determined as previously described.

In stage 3, the number of clickthroughs for any given rank is optionally determined, as previously described, based on the current webpage or on average statistics for clickthroughs for a particular type of business and geographic locality or other business factors and/or for a model webpage. Optionally, the webpage may be provided during a trial period, followed by pricing for clickthroughs, so that the initial rank may be determined.

In stage 4, the effect of making the suggested change on the mark-up language document is calculated according to a previously known rank (or a previously assumed rank, if for example the document is new). The calculation preferably comprises predicting the rank of the document as it is being edited and then determining the number of clickthroughs (as compared with current clickthroughs) using a model of user clickthrough behavior (an example of which is shown in the graph in FIG. 6B). Effectively, as the editing changes the predicted ranking of the mark-up language document, then a predicted change in the number of clickthroughs may optionally be determined according to a model of expected user behavior.

As an overall, illustrative, non-limiting example, assume that the user has a webpage that has a certain rank on a specific search engine. Based on the traffic for certain relevant keywords, traffic via that search engine for that keyword can be determined (alternatively or additionally, such information can be obtained through analytics instrumentation on the user's website).

This rank for that specific keyword brings in a certain amount of traffic. Potential changes that can be made (in order to improve ranking) can then be plotted on a graph (see FIG. 6b) in order to estimate how ranking improvements will increase traffic (in accordance with user click-through behavior).

The suggested changes are then implemented, after which the new predicted rank can be determined. This new predicted rank is determined according to the changes that are implemented, as the user for example may not make all of the suggested changes; still, even if only part of the changes are made, the website should still benefit from improved ranking. This new predicted rank will have a different estimated traffic and a relative improvement over the current rank/traffic.

Optionally, depending on the traffic and clickthrough behavior for keywords related to certain businesses, pricing can be determined for the webpage, website, or webpage changes. That is, pricing can be a factor of benefit to the customer (as is any performance related marketing such as click-through advertising). Pricing based on traffic for that business category, cost of customer/lead acquisition, conversion rates and so on will lead to a pricing strategy based on these and other parameters. As the extent of the benefit increases (because of increased ranking and therefore the number of visitors coming to the site), the price that can be charged may also be increased.

FIG. 7 relates to an exemplary, illustrative method according to some embodiments of the present invention for reputation management. In stage 1, a search is conducted for the name of a brand, company or person, by using an Internet search engine. In stage 2, a lexicon is generated as previously described in corresponding U.S. Provisional Application No. 61/586,843, filed on 16 Jan. 2012, having at least one inventor in common with the present application and being co-owned with the present application, which is hereby incorporated by reference as if fully set forth herein.

In stage 3, a user grades this lexicon to determine which words are relevant and whether words are positive, negative, or neutral. The user may for example optionally be a representative for a brand or company, or may optionally be the actual person (if the reputation management is being performed for a person). In stage 4, the reputation score is determined according to the graded lexicon.

In stage 5, one or both of two different methods to improve the reputational score may optionally be performed. A first method involves creating new content, for example on the related website for the person, brand or company, or on other websites, which is optimized for search engines as described herein. A second method involves building a topic model around the name of the brand, company or person, and then posting content which addresses the negative aspects of the topic model.

In stage 6, after the new content is posted, the reputational score is again determined. Optionally, the reputational score can be monitored on certain websites only or overall.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for providing efficient suggestions for changing a mark-up language document, the method being performed by a computer, the method comprising mapping an input feature space for the document into a decorrelated and orthogonal feature space; determining influence of said decorrelated feature space to ranking of the mark-up language document; determining at least one alteration to at least one feature in said decorrelated feature space to improve said ranking of the mark-up language document; and transforming said at least one feature to said input feature space to form an efficient suggestion for changing the mark-up language document.

2. The method of claim 1, further comprising bounding a plurality of proposed changes to determine whether said changes are efficient.

3. The method of claim 2, wherein said bounding further comprises analyzing the mark-up language document according to a template; and determining whether a change is to a content of the mark-up language document or to a structure of the mark-up language document; and giving additional weighting to said change to said content.

4. The method of claim 3, wherein said bounding further comprises determining whether to perform a change according to said weighting of said change.

5. The method of claim 3, wherein said bounding further comprises ranking a change according to a relative difficulty of performing said change.

6. The method of claim 5, further comprising determining a plurality of changes; ranking said plurality of changes according to said relative difficulty of performing said changes; presenting ranked changes to the user; and allowing the user to select one or more changes from said ranked changes to perform.

7. The method of claim 6, further comprising determining a price for said ranked changes according to said ranking and according to a predicted increased ranking of the document.

8. The method of claim 1, wherein said mapping said input feature space further comprises performing a method of eigenvector space mapping; and according to said mapping, providing one or more suggestions for optimal correction.

9. The method of claim 8, further comprising analyzing one or more higher order statistical features to determine ranking of the mark-up language document.

10. The method of claim 9, wherein said analyzing further comprises applying multivariate analysis.

11. The method of claim 10, wherein said higher order statistical features comprise one or more of entropy, variance, angular second moment, inverse difference moment, contrast correlation, and difference entropy.

12. The method of claim 1, wherein the mark-up language document comprises a webpage and wherein said ranking is determined by an Internet search engine.

13. The method of claim 12, wherein said transforming said at least one feature to said input feature space further comprises analyzing a business category parameter associated with said webpage; determining an improvement to said ranking according to said business category parameter; and determining an improvement also according to said improvement.

14. The method of claim 13, wherein said business category parameter is selected from the group consisting of business size, type of business, type of product or service provided, geographic location and competition, or a combination thereof.

15. A method for determining a number of guaranteed views for a webpage, the method being performed by a computer, the method comprising analyzing current views and search engine ranking for the webpage; analyzing the webpage according to the method of claim 1 to determine at least one efficient change; and determining an expected number of guaranteed views according to an expected change in search engine ranking after performing said at least one efficient change.

16. The method of claim 15, wherein said ranking is determined by an Internet search engine.

17. The method of claim 16, wherein said transforming said at least one feature to said input feature space further comprises analyzing a business category associated with said webpage; determining an improvement to said ranking according to said business category; and determining an improvement also according to said improvement.

18. The method of claim 15 further comprising determining a price for performing said efficient change and for guaranteeing said number of views.

19. The method of claim 18, wherein said determining said price comprises determining a current expected number of views from said analyzing said current views and search engine ranking, such that said price is set according to a difference between said current views and ranking, and said number of guaranteed views.

20. The method of claim 19, wherein said ranking is determined by an Internet search engine, wherein said determining said price further comprises analyzing a business category associated with said webpage; and determining said price also according to said improvement.

21. A method for reputational management for a name, wherein said name is associated with a brand, a company or a person, the method being performed by a computer, the method comprising determining a lexicon for the name; grading the lexicon for words that are positive, negative or neutral; and computing a reputational score according to said grading.
